(19) United States
(12) Patent Application Publication
(10) Pub. No.: US 2011/0053639 A1
(43) Pub. Date: Mar. 3, 2011

(54) METHODS AND DEVICES FOR AUTHENTICATING A PRODUCT AND A TWO-DIMENSIONAL CODE AND NOVEL APPLICATION OF A TWO-DIMENSIONAL CODE

(75) Inventors: Patricia Etienne Suanez, Le Pouliguen (FR); Roger Suanez, Le Pouliguen (FR)

(73) Assignee: ALCORIL HOLDINGS SA

(21) Appl. No.: 12/513,431

(22) PCT Filed: Oct. 31, 2007
(86) PCT No.: PCT/FR2007/001811

§ 371 Date: Dec. 15, 2009

(30) Foreign Application Priority Data
Nov. 3, 2006 (FR) 0609611

(51) Int. Cl. G06K 5/00; H04W 88/02

(52) U.S. Cl. 455/556.1; 235/375

(57) ABSTRACT

The invention relates to a method for authenticating a product from an analyte of the clarity of translucent blocks contained in a two-dimensional code, a method for authenticating a two-dimensional code and devices for carrying out said methods. The two-dimensional code affixed to a product is authenticated by analysing the level of clarity of translucent areas contained in the two-dimensional code and comparing the result of said analysis with a reference in a pre-established database. The two-dimensional code is authenticated by selectively marking certain dark areas of the two-dimensional code according to the character chain encoded during an encoding step and comparing the position of the marked dark areas with the position defined by the character chain during a decoding step. The invention also relates to a novel application of said two-dimensional code.

The present invention relates to a method for authenticating a product by analyzing the brightness of translucent areas included in a two-dimensional code applied to the product, a method for authenticating a two-dimensional code by marking and analyzing certain zones of the two-dimensional code, and the devices for implementing these methods. The present invention also relates to a novel application of a two-dimensional code.

Most manufactured products have a marking to guarantee their traceability, particularly when they cross borders. In particular, in order to guard against the production of counterfeit products and make it possible to identify fakes during an inspection or seizure, most manufactured products have an identification code that is unique and, if possible, difficult to copy. The identification code is generally small in size so as to be inconspicuous on the substrate; and in order to make it more difficult to illicitly copy the product's identification code, the identification code is generally non-sequential.

In the prior art, various product coding and identification systems are known to the person skilled in the art. Two-dimensional codes, in particular, are widely used. They are generally in the form of a matrix composed of dark squares and light or translucent squares, the relative positions of which make it possible to encode a specific character string on the product. The character string can be a keyword or a concatenation of various keywords that refer to data contained in a database.

In this two-dimensional coding system family, the “QR Code” (registered trademark) is one of the most widely used, particularly in Japanese industry. It is used, in particular, to quickly enter personal information into a mobile telephone, the personal information being for example displayed on a business card, using a photograph of the code and a data processing software. Another frequently used coding system is the public coding system known as “Data Matrix” (registered trademark). Its most widespread application is in the electronics industry, for example for smart card marking, but also sometimes for wine bottle identification. The matrix of the “Data Matrix” coding system is composed of a data encoding zone called a “data zone” having a combination of dark squares and adjacent translucent squares, this data zone being surrounded on two adjacent sides by two dark lines called the “start bars,” and on the other two sides by two other lines having alternating dark squares and translucent squares and called the “density indicator bars.” The squares are hereinafter called “areas.”

The “Data Matrix” matrix coding system works as follows: A character string representing a piece of information characterizing the product, which must be encoded into the matrix, is first binarized according to a predefined encoding protocol, for example in 7-bit ASCII format in the ECI (Extended Channel Interpretation) protocol. These binary data are then represented in the form of translucent areas and dark areas, generally representing a 0 bit and a 1 bit, respectively. The arrangement of the dark and translucent areas of the various elements of the character string in the data zone follows a specific order, known to the person skilled in the art. The translucent areas make it possible to leave the substrate visible. The dark areas, on the other hand, are generally opaque, created by printing with a dark ink, and do not make it possible to see the underlying substrate.

In addition to this encoding of the information characterizing the product, a read error correction system is encoded into the “Data Matrix.” This makes it possible to reconstruct and rectify data that are poorly printed, erased, blurred or torn off. The error correction mechanism is based on the Reed-Solomon codes, generally in accordance with the ECC (Error Correction Code) 200 standard.

The “Data Matrix” two-dimensional coding system makes it possible to encode a character string, typically of ten or several tens of characters, with matrices of very small size, typically a few square millimeters or tens of millimeters, making this coding system inconspicuous when it is affixed to the product. Moreover, the translucent and dark areas can be read with an adapted optical system and decoded even with a low contrast between the dark areas and the translucent areas.

This identification system nevertheless suffers from several flaws. In essence, while the small size of the matrix makes it difficult to copy, the “Data Matrix” system in the prior art is not unforgeable. A counterfeiter who has produced a fake product can relatively easily attach to it a “Data Matrix” code that is similar to the one found on an original product. The coding system in the prior art does not provide information on the product itself but on the character string that has been encoded on it.

Another product identification system known in the prior art consists of using a high-magnification optical imaging system to analyze the random variations in the structure of the material of the product. Every manufactured product has a specific fingerprint, a random structure linked to the way in which it was produced and/or to the very nature of the material that constitutes the product. By comparing the surface structure of the material analyzed with that of a reference standard, it is possible to determine based on predefined criteria whether or not the seized product is a fake.

However, this authentication system requires using two detection systems. In addition to the conventional system for reading the character string affixed in the form of, for example, a “QR code” or a “Data Matrix,” a second imaging and data processing device must be used to analyze the structure of the material.

The object of the present invention is to overcome one or more drawbacks of the prior art and in particular to propose a method for authenticating a product using a two-dimensional coding system.

The present invention relates to a method for authenticating a product to which is affixed a two-dimensional code representing a character string in the form of an arrangement of dark areas and non-dark areas located in a data encoding zone, and in the form of an arrangement of dark areas and non-dark areas located on the periphery of the data encoding zone, the non-dark areas, hereinafter called “translucent areas,” leaving the substrate of the product visible, characterized in that it comprises the following steps:

a step for reading and storing the two-dimensional code in the form of encoded values of electric signals associated with the intensity of a luminous flux emanating from areas of the two-dimensional code,

a step for processing an image from stored encoded values, consisting of creating a value matrix in which each element is associated with an area of the two-dimensional code,

a step for decoding the value matrix, making it possible to decode and store the character string,

a step for determining an average intensity value of a luminous flux emanating from at least two translucent areas located in the peripheral zone, by analyzing the encoded values of the electric signals,

an inversion/allocation step, consisting of creating a binary matrix in which each element is associated with an area of the two-dimensional code, using the value 0 for the elements associated with the dark areas and the translucent areas whose encoded value is lower than the average electric signal value, and the value 1 for the elements associated with the translucent areas whose encoded value is higher than the average electric signal value,

a step for performing a calculation on the binary matrix, the result of which determines a tested code,

a step for connecting with a database and comparing the tested code with a predetermined applied code, the two codes being associated with a reference.

According to one feature, the method is characterized in that the two-dimensional code is produced using a “Data Matrix” coding system comprising a data zone, two start bars, and two density indicator bars; the data encoding zone corresponds to the data zone; and the peripheral zone corresponds to the two density indicator bars.

According to another feature, the method is characterized in that the two-dimensional code is produced using a “QR Code” coding system, the data encoding system corresponds to the data zone of the QR Code, and the peripheral zone (3) corresponds to the three start zones located in three of the four corners of the QR Code.”

According to another feature, the method is characterized in that the image processing step comprises a segmentation of the areas of the two-dimensional code.

According to another feature, the method is characterized in that the decoding step is performed using a decoding protocol stored in a memory to which the image processing software has access.

According to another feature, the method is characterized in that the calculation step consists in the calculation of a polynomial consisting, for each bit of a binary matrix having the binary value of 1, of multiplying this value by two, of raising the result to a power, this power being determined so as to be the number of columns present in the binary matrix from which is subtracted the number of the column in which the bit for which the calculation is being performed is located, such that the first column is located on a predefined edge of the binary matrix, then of adding all of these results, i.e.

$$P = {\sum }_{i} ( {\sum }_{j} {( 2 \times {N ( 1 )}_{i , j} )}^{( {N}_{b} - j )} ) ,$$

where i is the number of the row of the binary matrix such that the first row is located on a predefined edge of the binary matrix, j the number of the column, N_{b} the number of columns present in the binary matrix, N(1)_{i,j} the binary value equal to 1 of the area located in the row i and the column j, the term

$${\sum }_{j} ( )$$

signifying a summation of all the terms in the parentheses for j varying from 1 to N_{b}, and the term

$${\sum }_{i} ( )$$

signifying a summation of all the terms in the parentheses for all of the existing values of i.

According to another feature, the method is characterized in that the comparison and connection step defines the product as being a fake if the tested code and the applied code corresponding to the same character string are different.

According to another feature, the method is characterized in that the applied code is calculated from the two-dimensional code of a product prior to its distribution.

According to another feature, the method is characterized in that the common reference used for the comparison step is the character string, or a part of the character string.

Another object of the present invention is to propose a novel application of a two-dimensional code.

The invention relates to a novel application of a two-dimensional code affixed to a product, the two-dimensional code representing an encoded character string in the form of an arrangement of dark areas and non-dark areas comprised in a data encoding zone, other non-dark areas being positioned on the periphery of the data encoding zone, the non-dark areas making it possible to leave the substrate of the product visible and being called “translucent areas,” characterized in that the translucent areas of the two-dimensional code are used to authenticate the product by analyzing their brightness.

Another object of the present invention is to propose a method for authenticating a two-dimensional code.

The invention relates to a method for authenticating a two-dimensional code (1) encoding a character string (70) by means of alternating dark areas (10) and non-dark areas (11) located in a data encoding zone, and by means of other dark areas (13) and other non-dark areas (14) located in a peripheral zone (3) on the periphery of the data encoding zone, the non-dark areas (11, 12, 14) hereinafter being called “translucent areas” and leaving the substrate of the product visible, characterized in that it comprises an encoding step and a decoding step such that the encoding step comprises:

a first calculation step, by means of an encoding software, making it possible to determine a representative numerical value (30) of the encoding of the character string (70),

a first density allocation step, by means of the encoding software, consisting of determining the positions of marked dark areas (17) in the peripheral zone (3) via a second calculation step based on the representative numerical value (30),

a step for printing and marking the two-dimensional code, consisting of printing the two-dimensional code on the product and adding a marker to the marked dark areas (17), and the decoding step comprises:

a step for reading and storing the two-dimensional code, using an adapted device, making it possible to store electric signals associated with areas of the two-dimensional code, and to distinguish the positions of the marked dark areas (17) and the unmarked dark areas (18) of the peripheral zone (3),

a step for decoding the two-dimensional code, by means of an image processing software, making it possible to decode and store the character string (70),

a third calculation step, by means of a decoding software, based on the encoding of the character string and using the same algorithm as in the first calculation step, making it possible to determine the representative numerical value (30) of the encoding of the character string (70),

a second density allocation step, by means of the decoding software, according to the same protocol as the first density allocation step, making it possible to determine a position of the marked dark areas (17) and the unmarked dark areas (18) via a calculation on the representative numerical value (30) of the encoding of the character string (70),

a step for comparing the positions of the marked dark areas (17) and the unmarked dark areas (18) determined by the second density allocation step and by the reading and storage step.

According to one feature, the method is characterized in that the two-dimensional code is produced using a “Data Matrix” coding system comprising a data zone, two start bars, and two density indicator bars, and the peripheral zone is associated with the two density indicator bars.

According to another feature, the method is characterized in that the two-dimensional code is produced using a “QR Code” coding system, and the peripheral zone corresponds to at least one of the three start zones located in three of the four corners of the “QR Code.”

According to another feature, the method is characterized in that the first step for calculating the representative numerical value of the encoding of the character string consists of calculating the remainder of a division of a first term by a second term, the second term being called the prime number of the character string, the first term being either a product of the ASCII codes of the characters of the character string or the result of a multiplication of the remainders of divisions of a product of the ASCII codes of the characters of the character string by the prime number of the character string, or any other combinations of remainders of divisions of products of the ASCII codes of the characters of the character string by the prime number of the character string and the product of these division remainders, so that the ASCII codes of all of the characters in the character string are involved in the calculation step, the prime number of the character string being the nearest prime number less than the number two raised to the power of the number of characters contained in the character string.

According to another feature, the method is characterized in that the first and second density allocation steps consist of assigning the representative numerical value to a dark area located at one end in contact with a start bar of one of the density indicator bars, of successively dividing the representative numerical value by two, taking into account only the whole part of the division, of successively assigning each of the results of this division to a dark area of the density indicator bars, beginning with the dark area nearest the area with which the representative numerical value is associated and ending with the dark area of the density indicator bars located on the side diagonally opposite the dark area to which the representative numerical value is assigned, of calculating the remainder of the division by the number two of each of the results of the division of the representative numerical value, and of assigning each of these division remainders to the same dark area of the density indicator bars with which each of the results of the division of the representative numerical value by two are associated.

According to another feature, the method is characterized in that the marking consists of modifying the contrast of the dark areas and/or of adding to the marked areas an ink having different physicochemical properties than the ink used for the unmarked areas.

Another object of the present invention is to propose a device for implementing the method for authenticating a product.

The invention relates to a device for authenticating a product to which is affixed a two-dimensional code (1) representing a character string in the form of an arrangement of dark areas (10) and non-dark areas (11, 12), comprising an optical imaging device (100), a device for converting an optical signal to an analog electric signal (110), an analog-digital converter (130), a memory (140), an image processing software (150) controlled by a microprocessor, and a means for connecting (160) with a database (170), the optical imaging device (100) being constituted by at least one lens for obtaining the imaging of the two-dimensional code (1) in the device for converting an optical signal to an analog electric signal (110), the device for converting an optical signal to an electric signal (110) being constituted by an array of photodetectors for converting a light signal to an analog electric signal which is converted to a digital electric signal by the analog-digital converter (130) and stored in the memory (140), and characterized in that the image processing software (150) includes means for:

segmenting areas of a two-dimensional code based on the analysis of the intensity of the electric signals stored in the memory,

creating a value matrix as a function of the result of the segmentation,

extracting a character string by decoding the value matrix according to a predetermined decoding protocol,

calculating an average electric signal value (22) from the values of the signals stored in the memory,

creating a binary matrix wherein each element corresponds to one area and wherein the value of the element depends on the values of the signals stored in memory and on the average electric signal value,

calculating, using a predefined algorithm, a tested code that depends on the binary matrix,

using the means for connecting (160) with a database (170) to compare the tested code with an applied code stored in a database (170) and referenced by a character string.

According to one feature, the device is characterized in that the optical imaging device, the device for converting an optical signal to an analog electric signal, the analog-digital converter, the image processing software, the memory and the means for connecting with a database are included in a telephone/digital camera.

According to another feature, the device is characterized in that the image processing software makes it possible to recognize the type of two-dimensional code affixed to the product by segmenting and analyzing specific zones of the two-dimensional code.

According to another feature, the device is characterized in that the protocol for decoding the value matrix is stored in a memory to which the image processing software has access, and the decoding protocol is adapted to the two-dimensional code.

According to another feature, the device is characterized in that the predefined algorithm of the image processing software consists in the calculation of a polynomial consisting, for each bit having the binary value of 1 in the binary matrix, of multiplying this value by two, of raising the result to a power, this power being determined so as to be the number of columns present in the binary matrix from which is subtracted the number of the column in which the bit of the binary matrix for which the calculation is being performed is located, such that the first column is located on a predefined edge of the binary matrix, then of adding all of these results, i.e.,

$$P = {\sum }_{i} ( {\sum }_{j} {( 2 \times {N ( 1 )}_{i , j} )}^{( {N}_{b} - j )} ) ,$$

where i is the number of the row of the binary matrix such that the first line is located on a predefined edge of the binary matrix, j the number of the column, N_{b} the number of columns present in the binary matrix, N(1)_{i,j} the binary value equal to 1 of the bit located in the row i and the column j, the term

$${\sum }_{j} ( )$$

signifying a summation of all the terms in the parentheses for j varying from 1 to N_{b}, and the term

$${\sum }_{i} ( )$$

signifying a summation of all the terms in the parentheses for all of the existing values of i.

According to another feature, the device is characterized in that the database is stored in a memory supported by the same device that houses the image processing software, and the connection means is an electric connection.

According to another feature, the device is characterized in that the database includes codes that have been applied to products prior to their distribution and that are referenced by a character string encoded on the products.

Another object of the present invention is to propose an encoding device for implementing the method for authenticating a two-dimensional code.

The invention relates to an encoding device for authenticating a two-dimensional code representing a character string, comprising a piece of encoding software connected to a memory and to a printing and marking means, characterized in that the encoding software can define binary marking values based on a calculation on the representative numerical value (30), and the printing and marking means can print the two-dimensional code on a product and mark certain dark areas with a marker as a function of the binary marking values.

According to one feature, the device is characterized in that the marker is a black ink, and/or a subtractive combination of inks of different colors, and/or an ink having metalloid properties, and/or an ink having magnetized elements.

Another object of the present invention is to propose a decoding device for implementing the method for authenticating a two-dimensional code.

The invention relates to a decoding device for authenticating a two-dimensional code representing a character string composed of dark areas, marked dark areas and non-dark areas, comprising a reading and storage device which includes an optical imaging device, a device for converting an optical signal to an analog electric signal, an analog-digital converter, a memory and a decoding software, the optical imaging device being constituted by at least one lens for obtaining the imaging of the two-dimensional code in the device for converting an optical signal to an analog electric signal, the device for converting an optical signal to an analog electric signal being constituted by an array of photodetectors for converting a light signal to an analog electric signal which is converted to a digital electric signal by the analog-digital converter and stored in the memory, characterized in that the decoding software can:

determine a value matrix representing the two-dimensional code by analyzing the intensity of the stored electric signals,

decode the value matrix so as to determine the character string according to a predefined decoding protocol,

calculate, using a predefined algorithm, a representative numerical value of the encoding of the character string, and determine, via a calculation on the representative numerical value, positions of marked dark areas and unmarked dark areas,

identify the positions of the marked dark areas and the unmarked dark areas by analyzing the stored electric signals,

compare the positions of the marked dark areas and the unmarked dark areas obtained via the analysis of the stored electric signals and via the calculation on the representative numerical value.

According to one feature, the device is characterized in that the optical imaging and storage device, the device for converting an optical signal to an analog electric signal, the analog-digital converter, the decoding software and the memory are included in a mobile telephone/digital camera.

According to another feature, the device is characterized in that the protocol for decoding the value matrix is stored in the memory, and this decoding protocol is adapted to the two-dimensional code.

Other features and advantages of the invention will emerge through the reading of the detailed description which follows, which may be understood by referring to the attached drawings, in which:

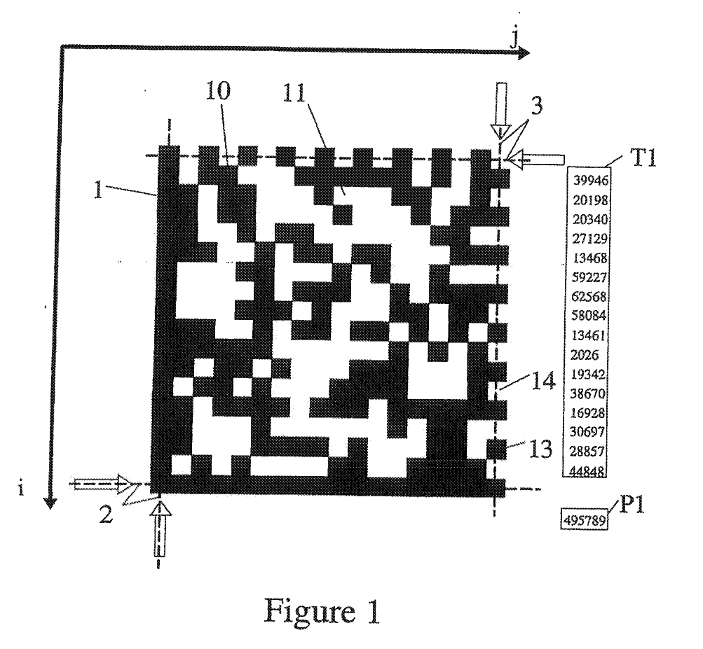

FIG. 1 illustrates an example of an unapplied two-dimensional “Data Matrix” code (called a “code prior to application”), and a step for calculating a code prior to application according to the product authentication method of the present invention.

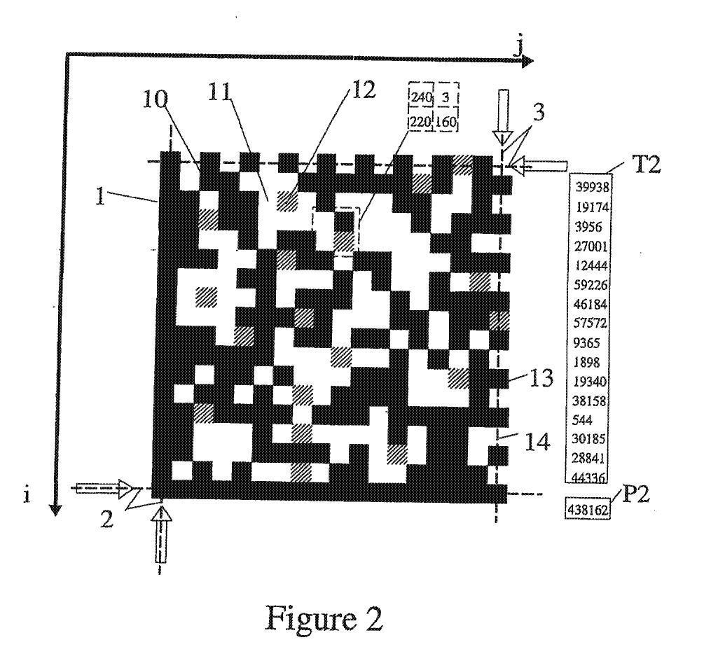

FIG. 2 illustrates an example of a “Data Matrix” code applied to a product, initially identical to the code in FIG. 1, certain translucent areas of which have been modified as a result of the texture of the product, along with a step for calculating an “applied code” according to the product authentication method of the present invention.

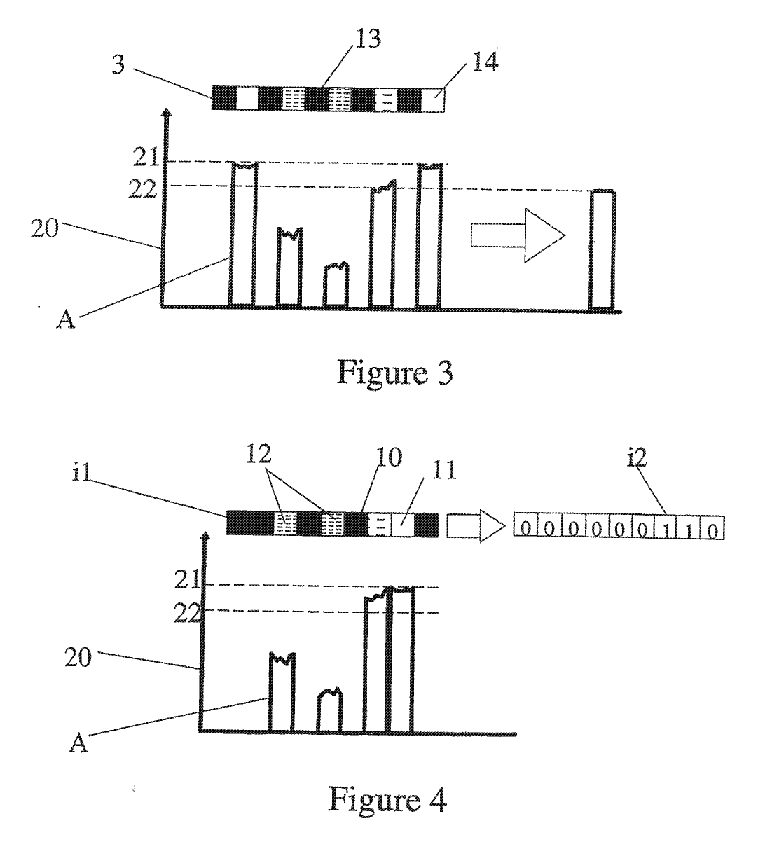

FIG. 3 schematically illustrates an analysis step according to the present invention in which an average intensity value of certain translucent areas of a two-dimensional code is determined.

FIG. 4 schematically illustrates an inversion/allocation step according to the present invention, in which a binary matrix, each element of which represents an area of a two-dimensional code, is created, and in which the value 0 or 1 is assigned to the areas based on their intensity.

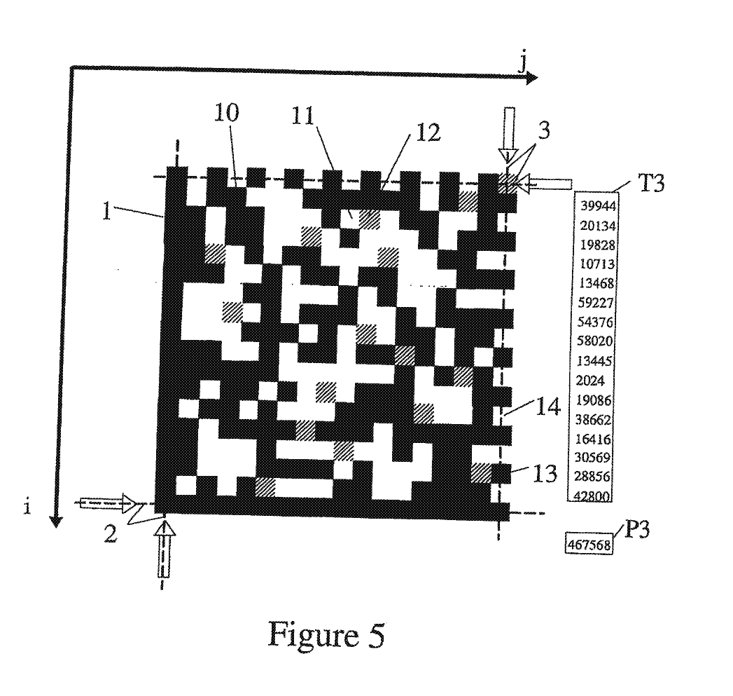

FIG. 5 illustrates an example of a “Data Matrix” code produced from a copy of an applied code and affixed to a simulated fake product, to be compared to the product onto which the “Data Matrix” code of FIG. 2 is affixed, along with a step for calculating a tested code according to the product authentication method of the present invention.

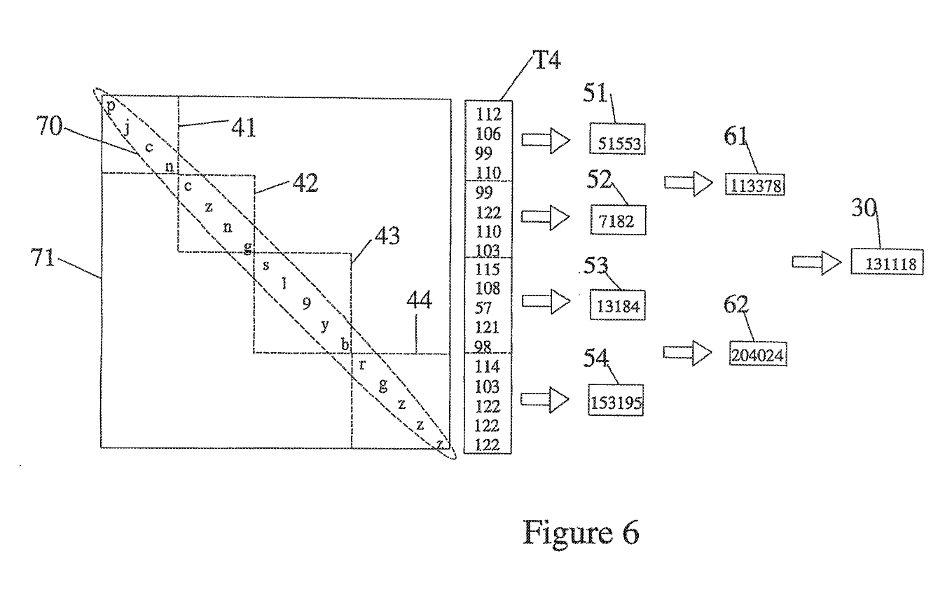

FIG. 6 schematically illustrates an example of a character string that must be encoded into a two-dimensional code, as well as a determination of a representative numerical value of the binary encoding of the character string according to the two-dimensional code authentication method of the present invention.

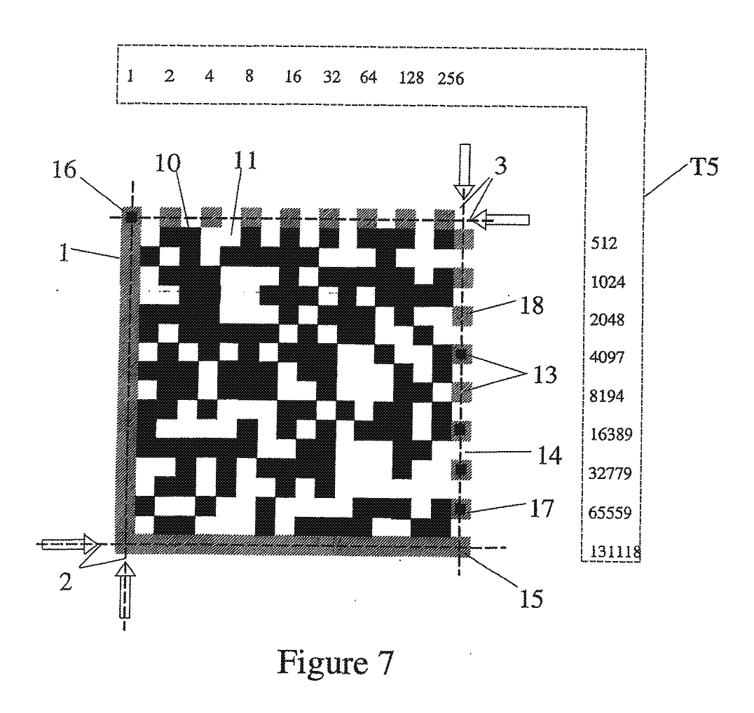

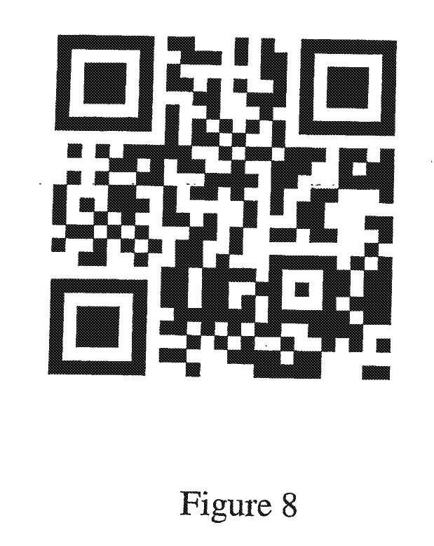

FIG. 7 illustrates an example of a method for authenticating a two-dimensional code according to the present invention, the two-dimensional code being a “Data Matrix” code representing the character string indicated in FIG. 6 according to an ASCII coding protocol.

FIG. 8 illustrates an example of a two-dimensional “QR Code” encoding information that must be affixed to a product.

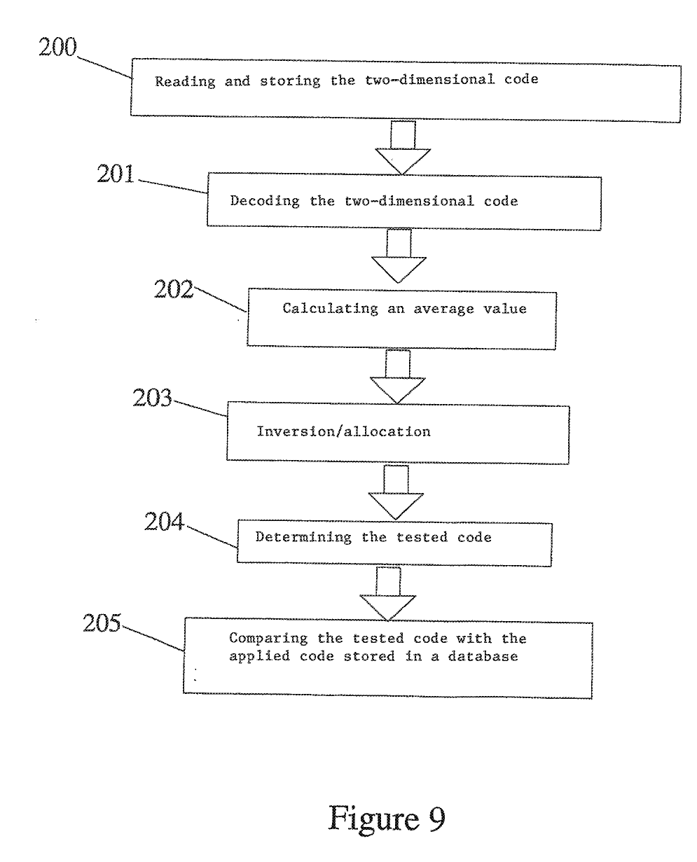

FIG. 9 schematically illustrates steps according to the product authentication method of the present invention.

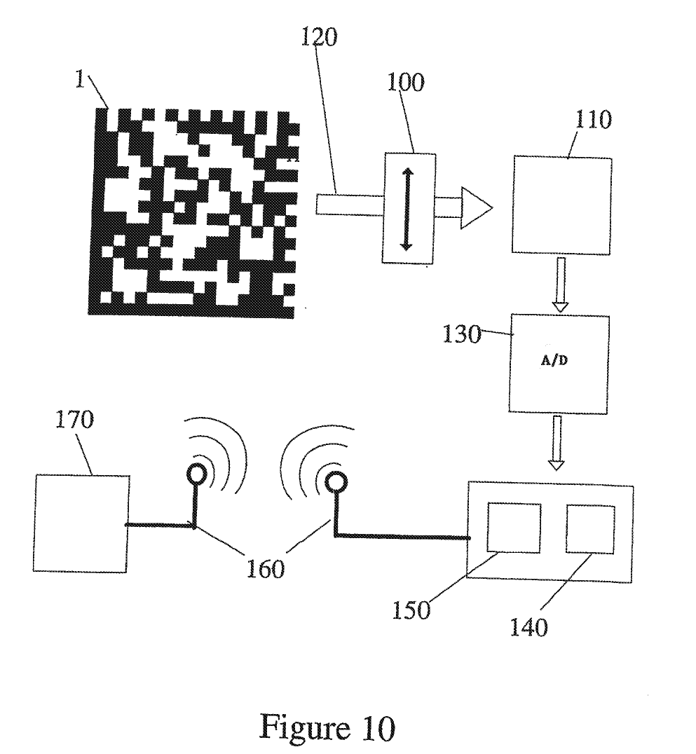

FIG. 10 illustrates an example of a device for implementing the product authentication method of the present invention.

The following description presents an exemplary embodiment of the methods for authenticating a product and authenticating a two-dimensional code according to the present invention, as well as a description of a conceivable embodiment of the devices for implementing these methods. This description is given for the “Data Matrix” two-dimensional encoding system, in particular. However, the methods and devices for implementing the methods of the present invention can be applied to all other forms of two-dimensional codes, including “QR Codes” or other types of codes.

Essentially, two-dimensional codes are in the form of an arrangement of dark areas and non-dark areas that make it possible to encode a character string. The areas can be squares, or any other forms whose arrangement makes it possible to encode a character string. Thus, it is equally conceivable for the two-dimensional code to be composed of an arrangement of triangles, diamonds, or other geometric figures representing a variable distribution of densities.

We will now describe an exemplary embodiment of the method for authenticating a product and an adapted device with the help of FIGS. 1 through 5 and 8 through 10.

The type of two-dimensional code that is affixed to the product can generally be identified by characteristic areas. For example, the “Data Matrix” code, an example of which is illustrated in FIG. 1, includes a data zone surrounded by two start bars (2) and two density indicator bars (3). The two start bars (2) are opaque. The density indicator bars (3) have alternating dark areas (13) and non-dark areas (14). These non-dark areas make it possible to leave the substrate of the product visible, and will hereinafter be called “translucent areas.” Generally, the brightness of the dark areas is lower than the brightness of the translucent areas. In the data zone, the arrangement of the dark areas (10) and the translucent areas (11) makes it possible to encode information, for example in ASCII code, i.e. to encode a character string characterizing a product. The row numbers of the data zone are associated with the letter i, and the column numbers of the data zone are associated with the letter j. In this example, the data zone comprises 16 rows and 16 columns. The first row and the first column, i.e. i=1 and j=1, characterize the area located in the data zone at the top left of the figure according to the orientation given in FIG. 1.

The dark areas (10, 13) are produced by being printed on the product with black ink, so that the areas are opaque and do not make it possible to see the underlying substrate. The translucent areas (11, 14) are formed without modifying the substrate, and particularly without ink printing, making it possible to leave the surface of the substrate visible through these areas.

In “Data Matrix” coding, the dark areas (10, 13) generally correspond to a bit equal to 1, and the translucent areas (11, 14) generally correspond to a bit equal to 0.

The method for authenticating a product begins with a step for reading and storing the two-dimensional code that is affixed to a product. The various steps of the method are shown in FIG. 9.

The adapted device, an example of which is given in FIG. 10, which makes it possible to perform this step for reading and storing (200) the two-dimensional code, comprises an optical imaging device (100) which makes it possible to collect a luminous flux (120) emanating from the surface of the product to which the two-dimensional code is affixed, using a lens or a set of lenses. The imaging device captures the image of the surface, and in particular an area in which the two-dimensional code is located, using a device for converting an optical signal to an analog electric signal (110).

The device for converting an optical signal to an analog electric signal (110) is constituted by an array of photodetectors. The photodetectors convert the luminous flux (120) to an analog electric signal, the intensity of which is dependent on the intensity of the luminous flux. Thus, a dark area of the two-dimensional code will emit a luminous flux intensity that is low compared to that of a translucent area.

The optical imaging device (100) and the device for converting an optical signal to an analog electric signal (110) make it possible to collect the luminous flux from each area of the two-dimensional code and to image each of the areas in at least one photodetector, so as to be able to spatially distinguish each of the areas.

The analog electric signals emitted by the photodetectors are read by an adapted reading device of the photodetectors and converted to digital electric signals by an analog-digital converter (130). The encoding of the analog-digital conversion depends on the desired precision of the intensity values of the analog electric signals. It is possible, for example and without limitation, to use a 7- or 8-bit encoding of the analog signal. The information related to this digital encoding is then stored in a memory (140). FIG. 2 shows, in a square formed by dotted lines, exemplary signal intensity values associated with four areas with 8-bit encoding, meaning that the signal representing the area can have a value between 1 and 256.

An image processing software (150) run by a processor connected with the memory (140) will process the information stored in memory (140), store new information, and modify both throughout the steps of the product authentication method described below.

The image processing software (150) processes the stored information and makes it possible to “segment” the two-dimensional code, i.e. to distinguish the relative positions of the dark areas (10) and the translucent areas (11), and hence to associate each area of the two-dimensional code with one or more photodetectors in which the photon flux has been imaged. This analysis, included in the image processing step of the method of the present invention, is performed using one or more zones that are characteristic of two-dimensional codes. In the case of the “Data Matrix” two-dimensional code, the start bars (2) are opaque and perpendicular. The encoded and stored values corresponding to the intensity of the luminous flux of these areas are thus identifiable, and make it possible to determine the direction in which the code is read. The density indicator bars (3) of the “Data Matrix” code have alternating dark areas and translucent areas, and the two bars are perpendicular to each other. These two bars are also clearly distinguishable and make it possible to define, in particular, the size of an area.

The software can thus, by analyzing the encoded values, distinguish these characteristic zones, and thus the relative position of each area of the two-dimensional code.

Based on this segmentation, the image processing software creates a value matrix, each element of which is associated with an area of the data encoding zone. The encoded values corresponding to the intensity of the luminous flux of each area are compared with a threshold intensity value. If the encoded value is lower than the threshold intensity value, then the area is associated with one binary value in the value matrix, and if the encoded value associated with an area has a value higher than this threshold intensity value, then the area is associated with the complementary binary value in the value matrix.

This threshold intensity value can be predefined and pre-stored in the memory, and can be similar to the electrical intensity derived from the collection and optical-to-electric conversion of the luminous flux of a known dark area, yet slightly higher than that intensity. The threshold intensity value can also be determined by specifically analyzing each two-dimensional code. Thus, in the case of a two-dimensional code of the “Data Matrix” type, the density indicator bars have dark areas and translucent areas that alternate in a known order. The threshold intensity value can thus be specifically determined in each two-dimensional code so as to be higher than the encoded value associated with a dark area, and lower than the encoded value associated with a translucent area.

In the case of a two-dimensional code of the “QR Code” type, an example of which is given in FIG. 8, three identical zones, called the start zones, are located in three of the four corners of the two-dimensional code (in this case on the top right and left and bottom left, according to the orientation of the figure). In this example, the three start zones are constituted by a black center square comprising nine adjacent dark areas, surrounded by translucent areas the thickness of one area, which are in turn surrounded by dark areas. A fourth zone, constituted by a single dark area, is located in the fourth corner. These various zones are characteristic of the “QR Code”-type two-dimensional code. These three identical zones and this fourth zone allow the image processing software to determine the direction in which the code is read, and the positions of the various areas in the code.

The image processing software (150) stores the relative position of each area and the encoded value corresponding to the intensity of the luminous flux of each area. Generally, the encoded value associated with each area can be a combination of the electrical intensity emanating from several photodetectors in which the imaging device has produced the image of an area.

The values of the elements of the matrix created by the image processing software are generally as follows: the dark areas, for which the encoded value is lower than the threshold intensity value, correspond to a binary value of 1, and the complementary value 0 is given for the other areas.

After this image processing step, a decoding step (201) is performed, making it possible to identify the affixed character string in the two-dimensional code. The decoding is done using the value matrix determined in the preceding step. The image processing software (150) decodes the two-dimensional code (1) using a decoding protocol stored in memory. Optionally, there are several pre-stored decoding protocols, corresponding to several types of two-dimensional codes. In that case, an analysis by the image processing software of the value matrix makes it possible to identify the characteristic zones of the two-dimensional code, and thus to determine the type of the two-dimensional code, and hence the appropriate decoding protocol. The character string thus decoded is stored in the memory (140).

The step for determining an average value (202) consists of analyzing the encoded values representing the intensity of the luminous flux associated with certain areas of the peripheral zone (3) of the two-dimensional code. The image processing software (150) processes the stored encoded values and produces an average of these encoded values associated with certain predefined areas. For example, in the case of a “Data Matrix” two-dimensional code, certain translucent areas (14) of the density indicator bars (3) are used for the analysis. The encoded values represent an electric signal intensity, associated with a luminous flux intensity. The analysis consists of determining an average value of these electrical intensities (22) associated with the translucent areas (14) analyzed, which will be called the “average electric signal value.” FIG. 3 thus shows a part of one of the two density indicator bars (3) of a “Data Matrix” two-dimensional code. The diagram (20) schematically shows a comparison between the electric signal intensities (A) associated with various translucent areas (14) of the part of one of the two density indicator bars (3) analyzed. The average electric signal value (22) is thus determined by averaging these various electric signal intensities, or the hexadecimal or other codes representing the intensities. In the case of a “QR Code”-type two-dimensional code, given as an example in FIG. 7, the translucent areas of the peripheral zone on which the analysis step is performed can, for example, belong to one or more start zones.

The inversion/allocation step (203) consists of creating a binary matrix in which each element is associated with an area of the two-dimensional code, and in which the value of the elements depends on the intensity of the electric signal and of the average electric signal value. Thus, the binary matrix is created so that the translucent areas wherein the intensity of the electric signal is lower than the average value are associated with the binary value 0, and the translucent areas wherein the intensity of the electric signal is higher than the average value are associated with the binary value 1. The dark areas are associated with the value 0. This step is said to be an “inversion” step in the sense that the dark areas now have the value 0, unlike in the value matrix created in the image processing step, in which they had the value 1.

FIG. 4 shows any row (i1) of the data zone of a “Data Matrix” code. This figure illustrates the inversion/allocation step of the method of the present invention. The image processing software compares the intensity of the electric signal (A) associated with each translucent area (11, 12) of the data zone with the average electric signal value (22). The image processing software then assigns, to each element of a row (i2) of a binary matrix, values that depend on the result of this comparison: the binary value 0 is assigned to the elements associated with the areas wherein the intensity of the electric signal is lower than the average electric signal value (22), and the binary value 1 is assigned to the elements associated with the areas wherein the intensity of the electric signal is higher than the average electric signal value (22).

The translucent areas (12) for which the intensity of the electric signal (A) is lower than the average electric signal value (22) are called the altered translucent areas.

The calculation step will now be explained with the help of FIGS. 1, 2 and 5. FIG. 2 shows an example of the same two-dimensional code as in FIG. 1, but in this case as it is seen when affixed to a product. The altered translucent areas (12) (hatched areas) are less bright than other translucent areas (11). This difference in the brightness level comes from the texture of the product, which is not homogenous and which therefore has, among other things, rough areas, deformations or marks specific to the material used and/or to the way in which the product was designed.

In FIG. 1, numerical values (T1) represent the values obtained via the calculation of a polynomial Pᵢ for each row of the binary matrix associated with the two-dimensional code shown. The two-dimensional code of FIG. 1 is not affixed to a product, and thus it does not have any altered zones. That is why the binary matrix used in the calculation step is composed, for this figure, of elements having the value 1 for the translucent areas and 0 for the dark areas. The rows i and columns j associated with the data encoding zone identically correspond to the rows and columns of the binary matrix, since each value of the binary matrix is associated with an area of the data encoding zone. In this example, Pᵢ is defined for each line i by:

$${P}_{i} = {\sum }_{j} {( 2 \times {N ( 1 )}_{j} )}^{( {N}_{b} - j )}$$

where N_{b} is the number of columns in the data zone, i.e. in this case, N_{b}=16, i is the number of the row on which the calculation of the polynomial Pᵢ is performed, j is the number of the column considered in the calculation, and N(1)ⱼ is the binary value associated with the row i and the column j. The calculation is performed only for the areas with which the binary value 1 is associated, i.e. the translucent areas; N(1)ⱼ is therefore necessarily equal to 1 in this example. It is possible, however, to conceive of other polynomials in another implementation of the method. The term

$${\sum }_{j} ( )$$

signifies that the sum of the terms in the parentheses is performed for all of the existing values of j, i.e. from j=1 to j=N_{b}. Thus, according to this example, the calculation of the polynomial Pᵢ for the first row produces:

Pᵢ=(2×1)¹⁵+(2×1)¹²+(2×1)¹¹+(2×1)¹⁰+(2×1)³+(2×1)¹=39946.

A code “prior to application” (P1) is defined by the sum of the various values (T1) obtained by calculating the polynomial Pᵢ for each row i.

The same calculation step is performed on the binary matrix created in the inversion/allocation step associated with the code of FIG. 2. The two-dimensional code of FIG. 2 is affixed to a product, and it therefore has altered areas. The binary matrix associated with the code of FIG. 2 is therefore different from that associated with FIG. 1 because the inversion/allocation step has taken into account the differences in the luminous intensity of the translucent areas.

The calculation of the polynomial Pᵢ in each of the rows of the binary matrix associated with the data zone of the code of FIG. 2 therefore produces values (T2) that are different from the values obtained in FIG. 1 (T1), and the summation of the various values Pᵢ, i.e. the summation of the various values (T2), which produces a “tested code” (P2), shows a different result than the code prior to application (P1) previously obtained in FIG. 1.

FIG. 5 represents an example of a “Data Matrix” code, initially identical to that of FIG. 1 but affixed to a product that is different from the one to which the “Data Matrix” code of FIG. 2 was affixed. The product in this case is a fake, and its surface structure is different from that of the product to which the “Data Matrix” code of FIG. 2 was affixed. In this example, the number and the position of the altered translucent areas (12) are different from those shown in FIG. 2. Thus, applying the reading and storage, image processing, decoding, analysis, allocation/inversion and calculation steps according to the method of the present invention makes it possible to obtain the same character string as that of the two-dimensional code of FIG. 2, but the tested code (P3) derived from the sum of the results (T3) of the calculation of the polynomial Pᵢ for each row i is different from the tested code (P2) of FIG. 2.

In the step for connecting with a database, the device containing the image processing software (150) can also contain a means for connecting (160) with a server (170) (see FIG. 10). The connection allows the imaging processing software (150) to compare, or have the server compare, the tested code it has determined with an “applied code” contained in a remote database (170). Optionally, the database (170) is directly housed in the same device that houses the image processing software (150), and that device has the means for updating this database.

The “applied code” is a code that has been determined on a product using the steps of the method described above, prior to the distribution of the product. It is therefore represents an identification of the product via the analysis of the altered areas of the two-dimensional code that has been affixed to it. The database (170) contains the applied code of each product to which a two-dimensional code has been affixed. This applied code is referenced in the database (170). The reference can be, for example, the character string that is encoded onto the same product, or a part of the character string, or a piece of data that is obtained from the character string.

Thus, the step for connecting with the database (170) and for comparing (205) the tested code with the applied code makes it possible to authenticate the product. If the two values are different, for the same character string, the software can conclude that the product is a fake, and send a related message to a user.

The device comprising an optical imaging device (100), a device for converting an optical signal to an electrical signal (110), an analog-digital converter (130) and the memory (140) can be, for example, a mobile telephone that has a camera. The image processing software (150) can be loaded into the telephone/camera, or the latter can connect to a server that has the image processing software (150) and a memory and transfer the information the method requires. The database (170), too, can either be stored in the telephone/camera or can housed remotely. In that case, the telephone/camera has the ability to connect with a server that has the database (170).

Optionally, if during the comparison step the character string that has been decoded is not found in the database, or if the character string cannot be decoded because its encoding mode is wrong, the image processing software can then transmit a specific error message to an operator.

Thus, the two-dimensional code simultaneously handles the encoding of information characterizing the product, while allowing the product to which the code is affixed to be authenticated by analyzing the brightness of certain zones of the two-dimensional code according to the product authentication method of the present invention.

We will now describe the method for authenticating a two-dimensional code and an exemplary code encoding device and code decoding device for implementing this method according to the present invention, with the help of FIGS. 6 and 7.

FIG. 6 illustrates an exemplary character string (70) that comprises 18 characters characterizing a product and that one wishes to encode using a two-dimensional coding system. The character string (70) is symbolically placed in a matrix (71) which represents a matrix of a two-dimensional code. Each character of the character string (70) has an ASCII code known to the person skilled in the art, the values of which (T4) are shown next to the matrix (71).

The encoding of this character string according to a known protocol thus defines a value matrix, each bit value of which will subsequently be associated with an area of the two-dimensional code.

In the encoding step, a calculation step is performed by an encoding software on values of the character string (70) encoded according to a predefined encoding protocol, for example in ASCII, in order to determine a representative numerical value (30) of the character string (70). In this nonlimiting example, the calculation step is constituted by a series of calculations which are explained below:

First, the nearest prime number lower than the number two raised to the power of the number of characters (for example 18) comprised in the character string (70) is determined, i.e. the nearest prime number lower than 2¹⁸, or 262139. This prime number is hereinafter called the prime number of the character string.

Next, the character string (70) is divided into four approximately equal groups. In this example, the first four characters form a first group (41), the next four characters form a second group (42), the next five characters form a third group (43), and the last five characters form a fourth group (44).

Then, the ASCII codes (T4) of each character of a same group are multiplied by each other, making it possible to obtain a single numerical value produced for each group (41, 42, 43, 44). Next, the division of the numerical value produced from each group (41, 42, 43, 44) by the prime number of the character string produces a remainder, making it possible to obtain a numerical value called a modulo value (51, 52, 53, 54) for each of the groups.

The modulo values (51, 52, 53, 54) are then multiplied by each other in pairs, so that the modulo value of the first group (51) is multiplied by that of the second group (52), and the modulo value of the third group (53) is multiplied by that of the fourth group (54), thus making it possible to obtain two numerical values produced from the modulo values.

The remainder of the division of these two numerical values produced from the modulo values by the prime number of the character string is then determined, making it possible to obtain two new numerical modulo values (61, 62).

Lastly, these two new numerical modulo values (61, 62) are multiplied by each other, and the remainder of the division of this last product by the prime number of the character string is determined, this remainder being the representative numerical value (30) of the character string (in the example of FIG. 6, the value 131118).

In the density allocation step, the encoding software assigns, as a function of the representative numerical value, a binary marking value to the elements of the value matrix that represent dark areas and are located in a peripheral zone (3) of the two-dimensional code. FIG. 7 thus schematically illustrates this allocation step in the particular case of a “Data Matrix”-type code encoding the character string (70) in ASCII format, according to one possible allocation mode. The arrangement of the dark areas and non-dark areas of the “Data Matrix” code is associated with the value matrix; the dark areas represent, for example, a bit equal to 1 and the non-dark areas represent a bit equal to 0. The representative numerical value (30) obtained is associated with a dark area (15) located at one end in contact with one of the start bars (2) of one of the density indicator bars (3), in this case on the bottom right according to the orientation of FIG. 7. The representative numerical value (30) is successively divided by two, taking into account only the whole part of the result of the division, and each result (T5) of this division is successively and continuously associated with a dark area (13) of the density indicator bars (3), beginning with the dark area adjacent to the dark area (15) with which the representative numerical value (30) is associated, and ending with the dark area (16) located at the diagonally opposite end, so that all of the dark areas (13) of the density indicator bars (3) are associated with a numerical value (T5).

Each term of the result of the division (T5) is divided by two, making it possible to obtain a binary remainder of this division having a value equal to 0 or a value equal to 1, called a binary marking value, each of these binary marking values being associated with the same dark area (13) of the density indicator bars (3) with which the successive results (T5) of the division of the representative numerical value (30) by two were associated.

In the case of a two-dimensional code of the “QR Code” type, an example of which is given in FIG. 8, the density allocation is performed, for example, on the dark areas located in the start zones, or in a single start zone.

After this density allocation step, a printing and marking step makes it possible to print the two-dimensional code representing the value matrix on a product, and to mark certain specific dark areas. The printing and marking device is, for example, a printer. The dark areas (13) of the density indicator bars (3) associated with the binary marking value 1 are thus marked with the marking device, thus creating marked areas (17). The other dark areas, which are associated with the binary value 0, are not marked (18).

The marker can be, for example and without limitation, a black printing ink, to which metalloid molecules or magnetic molecules can be added. The marking can also be in the form of a modification of the contrast of the dark areas (13). In the exemplary application in which the contrast is modified, the dark areas (13) of the density indicator bars (3) are printed with gray ink. The dark areas (17) that need to be marked can be darkened by subtractive color synthesis using the printing and marking device.

An exemplary decoding step of the method of the present invention will now be described.

The step for reading and storing the two-dimensional code consists of using an adapted device to store the two-dimensional code (1) in a memory. For example, the device can be constituted by an imaging device, a device for converting an optical signal to an analog electric signal, an analog-digital converter, and a memory. The device makes it possible to store in a memory electric signals associated with the intensity of a luminous flux emanating from areas of the two-dimensional code, collected by the imaging device, captured by the device for converting an optical signal to an analog electric signal, and converted to a digital signal.

The reading and storage device can also be composed of an induction sensor, in the case where the marking is done with an ink that creates a magnetic field, or an infrared-sensitive sensor in the case where the marking ink has molecules that emit an infrared electromagnetic wave.

The reading and storage device of the decoding device can be, for example, a mobile telephone equipped with a camera and with the software that executes the processes corresponding to the method.

The step for decoding the two-dimensional code is similar to the step for decoding the two-dimensional code according to the method for authenticating a product of the present invention: A decoding software that has access to the memory in which the electric signals are stored segments the areas by recognizing characteristic areas of the two-dimensional code, creates a value matrix wherein each element is associated with an area, and decodes the value matrix based on a decoding protocol pre-stored in the memory. It thus obtains the character string that had been encoded and stores it in the memory.

In another variant of embodiment, the decoding software can, for example, be housed remotely, on a server. In that case, the reading and storage device is in contact with a connection means, and connects to the server in order to transmit it the stored information.

The calculation step in the decoding software is identical to the calculation step performed by the encoding software. Thus, the character string (70) that had been obtained is encoded according to the same predefined protocol as in the marking step (for example in 7-bit ASCII), and the encoded values are used to determine a representative numerical value of the encoding of the character string.

Likewise, the density allocation step performed by the decoding software is identical to the density allocation step performed by the encoding software. This step is performed using the representative numerical value of the encoding of the character string and the value matrix that was determined during the decoding step. The decoding software thus stores binary marking values associated with marked dark areas and unmarked dark areas in the peripheral zone (3), and stores these binary marking values in the memory.

In the comparison step, the decoding software loads the information related to the positions of the marked dark areas and the unmarked dark areas that were determined via the reading and storage step with those that were obtained during the allocation step. This step thus makes it possible to conclude that the product is “genuine” if the positions are identical and “fake” if the positions are different.

Lastly, the result of this comparison is transmitted to an operator, for example in a Boolean “true” or “false” format.

It should be clear to the person skilled in the art that the present invention allows for embodiments of the method in many other specific forms without going beyond the scope of application of the invention as claimed. Consequently, the present embodiment should be considered as an example, but may be modified in the range defined by the scope of the attached claims, and the invention should not be limited to the details given above.

1-27. (canceled)

28. A method for authenticating a product having affixed thereon a two-dimensional code representing a character string in the form of an arrangement of dark areas and non-dark or translucent areas located in a data encoding zone and on a periphery of said data encoding zone or peripheral zone, said non-dark or translucent areas leaving substrate of the product visible, comprising the steps of:
reading and storing said two-dimensional code in a form of encoded values of electric signals associated with intensity of a luminous flux emanating from said dark and non-dark areas of said two-dimensional code in a memory;
processing an image from stored encoded values by a microprocessor to generate a value matrix in which each element of said value matrix is associated with an area of the two-dimensional code;
decoding said value matrix by said microprocessor to extract said character string and storing said character string in said memory;
determining an average intensity value of said luminous flux emanating from at least two translucent areas located in said peripheral zone by said microprocessor by analyzing said encoded values of said electric signals;
generating a binary matrix in which each element of said binary matrix is associated with an area of said two-dimensional code by assigning value 0 to elements associated with said dark areas, assigning a binary value 0 to elements associated with said translucent areas whose encoded value is lower than an average electric signal value, and assigning a binary value 1 to elements associated with said translucent areas whose encoded value is higher than said average electric signal value;
calculating a tested code from said binary matrix by said microprocessor; and
connecting to a database and comparing said tested code to an applied code stored in said database to authenticate said product, said tested code and said applied code being associated with a common reference.

29. The method of claim 28, further comprising the step of producing said two-dimensional code using a Data Matrix coding system comprising a data zone, two start bars, and two density indicator bars; wherein said data encoding zone corresponding to said data zone and said peripheral zone corresponding to said two density indicator bars.

30. The method of claim 28, further comprising the step of producing said two-dimensional code using a QR Code coding system comprising a QR Code having a data zone and four corners; and wherein said data encoding zone corresponding to said data zone of said QR Code and said peripheral zone corresponding to three start zones located in three of the four corners of said QR Code.

31. The method of claim 28, wherein the step of processing comprises the step of segmenting said dark and non-dark areas of said two-dimensional code.

32. The method of claim 28, wherein the step of decoding said value matrix is performed using a decoding protocol stored in said memory accessible by an image processing software controlled by said microprocessor.

33. The method of claim 28, wherein the step of calculating said tested code comprises the step calculating a polynomial P for each bit of said binary matrix having the binary value 1, by raising a result of multiplying the binary value said each bit by two to a power and then adding results of said each bit; wherein said power is determined by subtracting column number of said each bit's location in said binary matrix from total number of columns present in said binary matrix such that column 1 or first column is located on a predefined edge of said binary matrix, said polynomial P being defined by equation
$$P = {\sum }_{i} ( {\sum }_{j} {( 2 \times {N ( 1 )}_{i , j} )}^{( {N}_{b} - j )} ) ,$$
where i is a row number i or i^{th} row of said binary matrix such that a first row is located on a predefined edge of said binary matrix, j is said column number j or j^{th} column of said binary matrix, N_{b} is the number of columns present in said binary matrix, N(1)_{i,j} is the binary value equal to 1 of an area located in the row i and the column j, the term
$${\sum }_{j} ( )$$
signifying a summation of all the terms in the parentheses for j varying from 1 to N_{b}, and the term
$${\sum }_{i} ( )$$
signifying a summation of all the terms in the parentheses for all of the existing values of i.

34. The method of claim 28, further comprising the step of determining the product as a fake if said tested code and said applied code corresponding to same character string are different.

35. The method of claim 28, further comprising the step of calculating said applied code from said two-dimensional code associated with said product prior to said product's distribution.

36. The method of claim 28, wherein the step of comparing comprises the step of comparing said tested code to said applied code stored in said database using said character string or a portion of said character string as said common reference.

37. The method of claim 28, further comprising the step of authenticating said two-dimensional code by:
encoding said character string by determining a representative numerical value of said character string by an encoding software using an algorithm and said encoding software being controlled by said microprocessor;
determining positions of marked dark areas in said peripheral zone by said encoding software based on a protocol and said representative numerical value to provide said two-dimensional code;
printing said two-dimensional code on the product and adding a marker to said marked dark areas in said peripheral zone;
reading said two-dimensional code by an adapted device and storing electric signals associated with areas of said two-dimensional code to distinguish positions of said marked dark areas and unmarked dark areas in said peripheral zone in said memory;
decoding said character string from said two-dimensional code by an image processing software controlled by said microprocessor and storing said character string in said memory;
determining said representative numerical value of said character string decoded from said two-dimensional code by a decoding software using said algorithm and said decoding software being controlled by said microprocessor;
determining the positions of said marked areas and said unmarked areas in said peripheral zone by said decoding software based on said protocol and said representative numerical value of said character string decoded from said two-dimensional code by said decoding software; and
comparing by said microprocessor, the positions of said marked dark areas and said unmarked dark areas as determined from the said representative numerical value of said character string by said decoding software and as read by said adapted device and stored in said memory.

38. The method of claim 37, further comprising the step of producing said two-dimensional code using a Data Matrix coding system comprising a data zone, two start bars, and two density indicator bars; and wherein said peripheral zone is associated with said two density indicator bars.

39. The method of claim 37, further comprising the step of producing said two-dimensional code using a QR Code coding system comprising a QR code having four corners; and wherein said peripheral zone corresponding to at least one of three start zones located in three of the four corners of said QR Code.

40. The method of claim 37, wherein the step of encoding said character string comprises the step of calculating a remainder of a division of a first term by a second term; wherein the second term is referred to as a prime number of the character string, the prime number being the nearest prime number less than two raised to a power of a number of characters contained in said character string; and wherein the first term is one of the following: a product of ASCII codes of characters of said character string; a result of a multiplication of remainders of divisions of the product of the ASCII codes of the characters of said character string by said first term; or a combination of remainders of divisions of products of the ASCII codes of the characters of the character string by said first term and the product of the remainders of the divisions so that the ASCII codes of all of the characters in said character string are utilized to determine said numerical value of said character string.

41. The method of claim 38, wherein the steps of determining positions of said marked areas and said unmarked areas by said encoding software and by said decoding software comprises the steps of:
assigning said representative numerical value to a dark area located at one end in contact with a start bar of one of said density indicator bars;
successively dividing said representative numerical value by two and taking into account only a whole part of the division;
successively assigning each result of the division to a dark area of said density indicator bars, beginning with a dark area nearest to said dark area assigned said representative numerical value and ending with a dark area of said density indicator bars located on a side diagonally opposite said dark area assigned representative numerical value;
calculating a remainder of the division by two each result of the division of said representative numerical value; and
assigning each remainder of the division to said dark area of said density indicator bars.

42. The method of claim 37, wherein the step of adding said marker comprises the step of either modifying contrast of said dark areas or adding said marker using a different ink having different physiochemical properties in said marked areas than said unmarked areas.

43. The method of claim 28, further comprising the step of authenticating the product by analyzing brightness of said translucent areas of said two-dimensional code affixed to the product.

44. A device for authenticating a product having affixed thereon a two-dimensional code representing a character string in the form of an arrangement of dark areas and non-dark or translucent areas located in a data encoding zone and on a periphery of said data encoding zone or peripheral zone, said non-dark or translucent areas leaving substrate of the product visible, comprising:
an optical image device comprising at least one lens for obtaining an image or an optical signal of said two-dimensional code;
an array of photo-detectors for converting said optical signal to an analog electric signal;
an analog-digital converter for converting said analog electric signal to a digital electric signal;
a memory for storing said digital electric signal;
a connecting device for connecting to a database; and
a microprocessor controlling an image processing software to:
segment areas of said two-dimensional code based on an analysis of intensity of said digital electric signals stored in said memory to provide segmented areas;
generate a value matrix as a function of said segmented areas;
extract a character string by decoding said value matrix according to a predetermined decoding protocol;
calculate an average electric signal value from values of said digital electric signals stored in said memory;
generate a binary matrix with each element corresponding to an area of said two-dimensional code and wherein a value of said each element depends on the values of said digital electric signals stored in said memory and on said average electric signal value;
calculate a tested code based on said binary matrix using a predefined algorithm; and
connect to said database via said connecting device to compare said tested code to an applied code stored in said database and referenced by said character string.

45. The device of claim 44 is incorporated in a telephone/digital camera device

46. The device of claim 44, wherein said microprocessor is operable to control said image processing software to recognize a type of said two-dimensional code affixed to the product by segmenting and analyzing predetermined zones of said two-dimensional code.

47. The device of claim 44, wherein said predetermined decoding protocol adapted to said two-dimensional code is stored in said memory and accessible to said image processing software.

48. The device of claim 44, wherein said microprocessor is operable to control said image processing software to use said predefined algorithm to calculate a polynomial for each bit of said binary matrix having a binary value 1, by raising a result of multiplying the binary value of said each bit by two to a power and then adding results of said each bit; wherein said power is determined by subtracting a column number of said each bit's location in said binary matrix from total number of columns present in said binary matrix such that column 1 or first column is located on a predefined edge of said binary matrix, said polynomial P being defined by equation
$$P = {\sum }_{i} ( {\sum }_{j} {( 2 \times {N ( 1 )}_{i , j} )}^{( {N}_{b} - j )} ) ,$$
where i is a row number i or i^{th} row of said binary matrix such that a first row is located on a predefined edge of said binary matrix, j is said column number j or j^{th} column of said binary matrix, N_{b} is the number of columns present in said binary matrix, N(1)_{i,j} is the binary value equal to 1 of an area located in the row i and the column j, the term
$${\sum }_{j} ( )$$
signifying a summation of all the terms in the parentheses for j varying from 1 to N_{b}, and the term
$${\sum }_{i} ( )$$
signifying a summation of all the terms in the parentheses for all of the existing values of i.

49. The device of claim 44, wherein said database is stored in said memory and wherein said connecting device provides an electric connection between said database and said image processing software.

50. The device of claim 44, wherein applied codes that have been applied to products prior to the products' distribution and each referenced by a character string encoded onto the products are stored in said database.

51. The device of claim 44, further comprising an encoding device for authenticating said two-dimensional code representing said character string and comprising an encoding software for determining a representative numerical value of said character string, calculating binary marking values from said representative numerical value; and a printing and marking device for printing said two-dimensional code on the product and marking certain dark areas with a marker as a function of said binary marking values.

52. The device of claim 51, wherein said marker is at least one of the following: a black ink, a subtractive combination of inks of different colors, an ink having metalloid properties, or an ink having magnetized elements.

53. An encoding device for authenticating said two-dimensional code representing a character string composed of marked and unmarked dark areas and non-dark areas, comprising:
an optical image device comprising at least one lens for obtaining an image or an optical signal of said two-dimensional code;
an array of photo-detectors for converting said optical signal to an analog electric signal;
an analog-digital converter for converting said analog electric signal to a digital electric signal;
a memory for storing said digital electric signal; and
a microprocessor controlling a decoding software to:
determine a value matrix representing said two-dimensional code by analyzing intensity of said stored digital electric signals;
decode said value matrix to determine an encoded character string according to a predefined decoding protocol;
calculate a representative numerical value of said encoded character string using a predefined algorithm;
determine positions said marked dark areas and said unmarked areas from said representative numerical value;
determine the positions of said marked dark areas and said unmarked dark areas by analyzing said stored digital electric signals; and
compare the positions of said marked dark areas and said unmarked dark areas obtained by analyzing said stored digital electric signals and as determined from said representative numerical value.

54. The encoding device of claim 53 is incorporated in a telephone/digital camera device.
